(19) United States
(12) Patent Application Publication
(10) Pub. No.: US 2015/0109570 A1
(43) Pub. Date: Apr. 23, 2015

(54) LIQUID CRYSTAL LENS AND PANEL AND DISPLAY DEVICE INCLUDING LIQUID CRYSTAL LENS PANEL

(71) Applicant: Samsung Display Co., Ltd., Yongin-City (KR)

(72) Inventors: Hyung Woo YIM, Goyang-si (KR); Hae Young YUN, Suwon-si (KR); Seung Jun JEONG, Hwaseong-si (KR); Kang-Min KIM, Hwaseong-si (KR); Jeong Min SUNG, Suwon-si (KR); Sung Woo LEE, Anyang-si (KR); Hyeon Yong JANG, Hwaseong-si (KR)

(21) Appl. No.: 14/308,582

(22) Filed: Jun. 18, 2014

(30) Foreign Application Priority Data
Oct. 23, 2013 (KR) 10-2013-0126511

(51) Int. Cl. G02F 1/1343; G02B 27/22

(52) U.S. Cl. CPC G02F 1/134309; G02B 27/2214
USPC 349/139

(57) ABSTRACT

A liquid crystal lens includes: a lower substrate; a plurality of driver pad wires positioned at an edge of the lower substrate; a lower lens electrode positioned at a center of the lower substrate; a plurality of wires of a wiring on the lower substrate positioned between the plurality of driver pad wires and the lower lens electrode; an upper substrate positioned facing the lower substrate; an upper lens electrode formed at a bottom surface of the upper substrate; a liquid crystal layer disposed between the upper substrate and the lower substrate; a plurality of first electrodes connecting the lower lens electrode and the plurality of wires of the wiring; and a plurality of second electrodes connecting the plurality of driver pad wires and the plurality of wires of the wiring, and a difference between a driver pad wiring period and a second electrode period is less than 1 μm

### CROSS-REFERENCE TO RELATED APPLICATION

This application claims priority to and the benefit of Korean Patent Application No. 10-2013-0126511 filed in the Korean Intellectual Property Office on Oct. 23, 2013, the entire contents of which are incorporated herein by reference.

### BACKGROUND

1. (a) Field of the Invention

The present invention relates to a liquid crystal lens panel and a display device including the same.

2. (b) Description of the Related Art

In general, a display device displays a 2D, planar image. Recently, as demand for 3D stereoscopic images has increased in fields such as gaming and movies, display devices capable of displaying 3D stereoscopic images are being developed.

A stereoscopic image display device divides a left-eye image and a right-eye image having binocular disparity and respectively provides them to a left eye and a right eye of an observer. The observer recognizes the left-eye image and the right-eye image through two eyes, and the above images are combined in the viewer's brain such that the viewer perceives stereoscopicity.

To provide the stereoscopic image, stereoscopic spectacles are used to make a linear polarization type of stereoscopic display device dividing the left-eye image and the right-eye image, however there is a difficulty that the spectacles must be worn by the viewer.

To solve this difficulty, methods of providing stereoscopic images that do not involving wearing of spectacles have been proposed. Such methods may be classified according to the type of element used to divide the image for each direction, and may include a lenticular type, a parallax type, an integral photography type, and a holography type device. Recently, the lenticular type of stereoscopic image display device has been the focus or research and development efforts.

A lens used in the lenticular type device may be a convex lens or a Fresnel lens. The Fresnel lens has a thinner thickness than the convex lens. The Fresnel lens has a plurality of circular arcs on a surface thereof. The Fresnel lens refracts light at the circular arcs.

A lenticular lens which uses a liquid crystal lens has been manufactured. In such a liquid crystal lens the lenticular lens is realized by controlling director distribution of liquid crystal through an electric field. The liquid crystal lens includes an upper substrate, a lower substrate, and a thick liquid crystal layer between the upper substrate and the lower substrate. The liquid crystal lens is made of a plurality of electrodes, and each electrode is supplied with a different voltage to control the liquid crystal director. Accordingly, the liquid crystal lens requires wiring and a driver supplying the voltage to the lens electrode, and a region corresponding to the wiring and the driver must be covered by a black matrix.

The above information disclosed in this Background section is only for enhancement of understanding of the background of the disclosure and therefore it may contain information that does not form the prior art that is already known in this country to a person of ordinary skill in the art.

### SUMMARY

A liquid crystal lens that minimizes a bezel and eliminates a fan-out portion between a driver and wiring caused by a period difference by minimizing a difference between a period of pad wiring of a liquid crystal lens driver and a period of an electrode connecting the wiring and the driver, and a display device applying the same are provided.

A liquid crystal lens panel includes: a lower substrate; a plurality of driver pad wires on the lower substrate positioned at an edge of the lower substrate; a lower lens electrode on the lower substrate positioned at a center of the lower substrate; a plurality of wires of a wiring on the lower substrate positioned between the plurality of driver pad wires and the lower lens electrode; an upper substrate positioned facing the lower substrate; an upper lens electrode formed at a bottom surface of the upper substrate; a liquid crystal layer disposed between the upper substrate and the lower substrate; a plurality of first electrodes connecting the lower lens electrode and the plurality of wires of the wiring; and a plurality of second electrodes connecting the plurality of driver pad wires and the plurality of wires of the wiring, wherein a distance between two adjacent driver pad wires is a driver pad wiring period and a distance between two second electrodes connected to the two adjacent driver pad wires is a second electrode period, and a difference between the driver pad wiring period and the second electrode period is less than 1 μm.

The liquid crystal lens panel may further include a driver connected to the driver pad wires.

More than 80% of wires among the driver pad wires may be connected to individual second electrodes of the plurality of the second electrodes.

A fan-out portion may not exist between the driver and the plurality of wires of the wiring

The lower lens electrode may include a group of a plurality of unit lens electrodes, and one unit lens electrode is formed of a plurality of separate branch electrodes, the branch electrodes in one unit lens electrode having a wider width closer to a center of the one unit lens electrode.

A number of the separate branch electrodes forming one unit lens electrode may be the same as a number of the wires of the wiring.

The branch electrodes may include first lens electrodes and second lens electrodes insulated from the first lens electrodes.

The first electrodes and the second electrodes may include indium zinc oxide (IZO).

A first electrode contact portion connecting a first electrode of the plurality of first electrodes to a wire of the wiring may be separated from a second electrode contact portion connecting a second electrode of the plurality of second electrodes to a wire of the wiring.

The separation distance between the first electrode contact portion and the second electrode contact portion may be between 1 μm to 10 μm.

The driver pad wires may include indium tin oxide (ITO).

The driver pad wires may include a metal.

A wire of the wiring connected to a center branch electrode that is largest among the branch electrodes forming the unit lens electrode may be connected to two or more second electrodes.

A display device includes: a display panel displaying an image; and a liquid crystal lens panel on the display panel, wherein the liquid crystal lens panel includes: a plurality of driver pad wires on the lower substrate positioned at an edge of the lower substrate; a lower lens electrode on the lower substrate positioned at a center of the lower substrate; a plurality of wires of a wiring on the lower substrate positioned between the plurality of driver pad wires and the lower lens electrode; an upper substrate positioned facing the lower substrate; an upper lens electrode formed at a bottom surface of the upper substrate; a liquid crystal layer disposed between the upper substrate and the lower substrate; a plurality of first electrodes connecting the lower lens electrode and the plurality of wires of the wiring; and a plurality of second electrodes connecting the plurality of driver pad wires and the plurality of wires of the wiring, wherein a distance between two adjacent driver pad wires is a driver pad wiring period and a distance between two second electrodes connected to the two adjacent driver pad wires is a second electrode period, and a difference between the driver pad wiring period and the second electrode period is less than 1 μm.

The display panel may be one selected from a group including a liquid crystal display (LCD) panel, an electrophoretic display panel (EDP), an organic light emitting display (OLED) panel, and a plasma display panel (PDP).

An interval maintaining layer made of a transparent glass or plastic may be positioned between the display panel and the liquid crystal lens panel.

More than 80% of wires among the plurality of driver pad wires of the liquid crystal lens panel may be connected to individual second electrodes of the plurality of the second electrode.

The liquid crystal lens panel may further include a driver positioned between the edge of the lower substrate and the plurality of driver pad wires, wherein a fan-out portion may not exist between the driver and the plurality of wires of the wiring.

A first electrode contact portion connecting a first electrode of the plurality of first electrodes to a wire of the wiring may be separated from a second electrode contact portion connecting a second electrode of the plurality of second electrodes to a wire of the wiring.

The lower lens electrode includes a group of a plurality of unit lens electrodes, and one unit lens electrode may be formed of a plurality of separate branch electrodes, the branch electrodes in one unit lens electrode having a wider width closer to a center of the one unit lens electrode, and a wire of the wiring connected to a center branch electrode that is largest among the branch electrodes forming the unit lens electrode may be connected to two or more second electrodes

As described above, the liquid crystal lens panel of the present disclosure minimizes a difference between the period of the pad wiring of the driver and the period of the electrode connecting the wire and the driver such that the fan-out portion between the driver and the wire is eliminated. As the fan-out portion is eliminated, a light blocking region of the liquid crystal lens is reduced by a length of the fan-out portion, thereby providing the display device with a thin bezel.

### BRIEF DESCRIPTION OF THE DRAWINGS

FIG. 1 is a top plan view of a liquid crystal lens panel according to an example embodiment.

FIGS. 2A and 2B are cross-sectional views showing a Fresnel lens structure, and FIG. 2C is a cross-sectional view of a liquid crystal lens according to an example embodiment taken along the line X-X of FIG. 1.

FIG. 3 is a cross-sectional view and a layout view of a lower lens electrode 300 of a liquid crystal lens according to an example embodiment.

FIG. 4 is a view of a connection of wiring and a liquid crystal lens according to an example embodiment.

FIG. 5 is a view of a connection shape of a driver of a liquid crystal lens, wiring, and a lower lens electrode according to a comparative example.

FIG. 6 is a view of a connection shape of a driver of a liquid crystal lens, wiring, and a lower lens electrode according to an example embodiment.

FIG. 7 is an enlarged view of a connection shape of a first electrode and a second electrode connected to wiring of a liquid crystal lens according to an example embodiment.

FIG. 8 is a cross-sectional view of a liquid crystal lens according to a comparative example taken along the line II-II of FIG. 5.

FIG. 9 is a cross-sectional view of a liquid crystal lens according to an example embodiment taken along the line III-III of FIG. 6.

FIG. 10 is a view of a liquid crystal lens according to another example embodiment.

FIG. 11 is a view of a display device applied with a liquid crystal lens according to an example embodiment.

### DETAILED DESCRIPTION OF THE EMBODIMENTS

The present disclosure will be described more fully hereinafter with reference to the accompanying drawings, in which example embodiments are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element, or intervening elements may also be present. In contrast, when an element is referred to as being “directly on” another element, there are no intervening elements present.

A liquid crystal lens and a display device including the same according to an example embodiment will be described with reference to accompanying drawings.

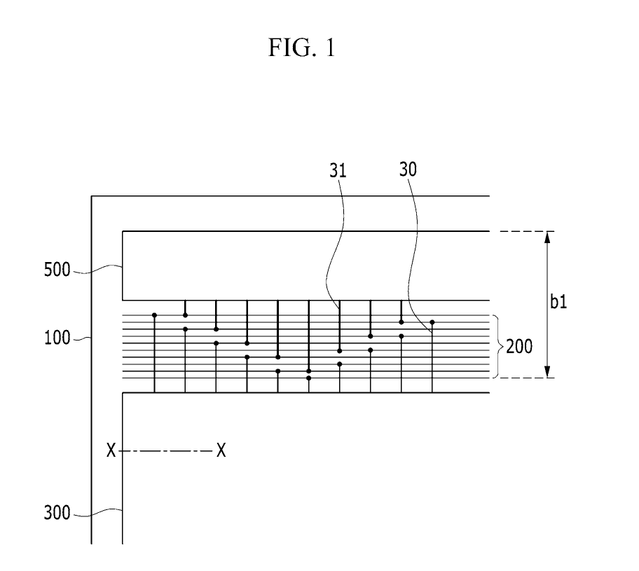

Firstly, a liquid crystal lens according to an example embodiment will be described with reference to FIG. 1 to FIG. 6.

FIG. 1 is a top plan view of a liquid crystal lens panel according to an example embodiment. As shown in FIG. 1, a driver 500, wiring 200, and a lower lens electrode 300 are formed on a lower substrate 100. The driver 500 is positioned at an edge of the substrate and is connected to the wiring 200 to supply a voltage to the lower lens electrode, and the wiring 200 is positioned between the driver 500 and the lower lens electrode 300.

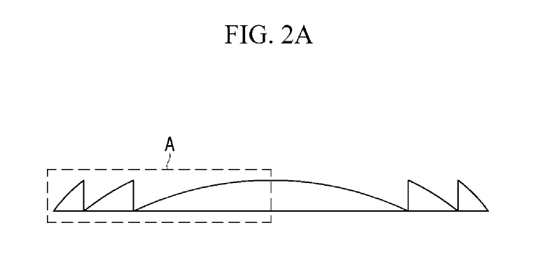

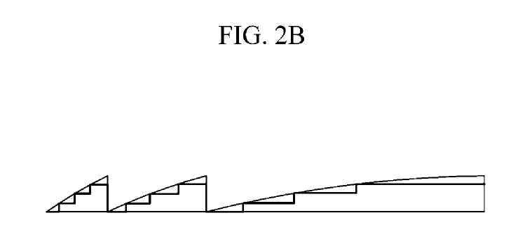

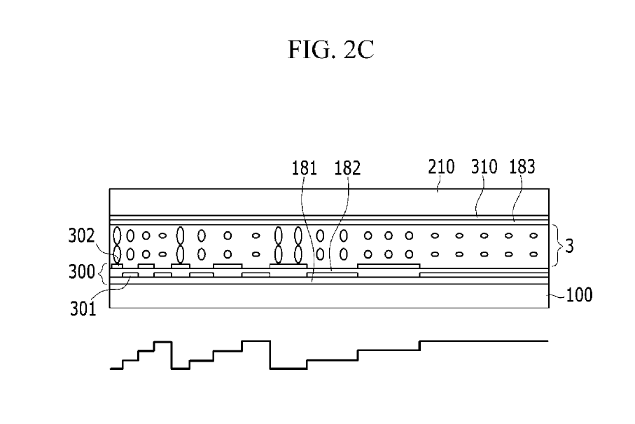

FIG. 2C is a cross-sectional view of the liquid crystal lens according to an example embodiment taken along the line X-X of FIG. 1. As shown in FIG. 2C, the liquid crystal lens includes the lower substrate 100, the lower lens electrode 300 on the lower substrate, an upper substrate 210 disposed to face the lower substrate, an upper lens electrode 310 on the upper substrate, and a liquid crystal layer 3 interposed between the lower substrate and the upper substrate. The lower lens electrode 300 includes a first lens electrode 301 and a second lens electrode 302 positioned so as to be separated from each other, and the first lens electrode 301, the second lens electrode 302, and the upper lens electrode 310 receive the voltage from the driver 500 to align liquid crystal molecules of the liquid crystal layer 3 interposed between the lower lens electrode 300 and the upper lens electrode 310. Each separate lens electrode is respectively applied with a different voltage, and according to the applied voltage, the alignment degree of the liquid crystal molecules is different.

Next, the lens electrode of the liquid crystal lens according to an example embodiment will be described. In the present disclosure, the lens electrode includes the lower lens electrode 300 made of a plurality of separate electrodes and the upper lens electrode 310 positioned so as to face the lower electrode. The upper lens electrode is formed with a whole plate shape, to substantially cover the upper substrate 210, and the upper lens electrode and the lower lens electrode are both transparent. However, the upper lens electrode may have a separate electrode structure of a similar shape to that of the lower electrode, rather than the whole plate shape.

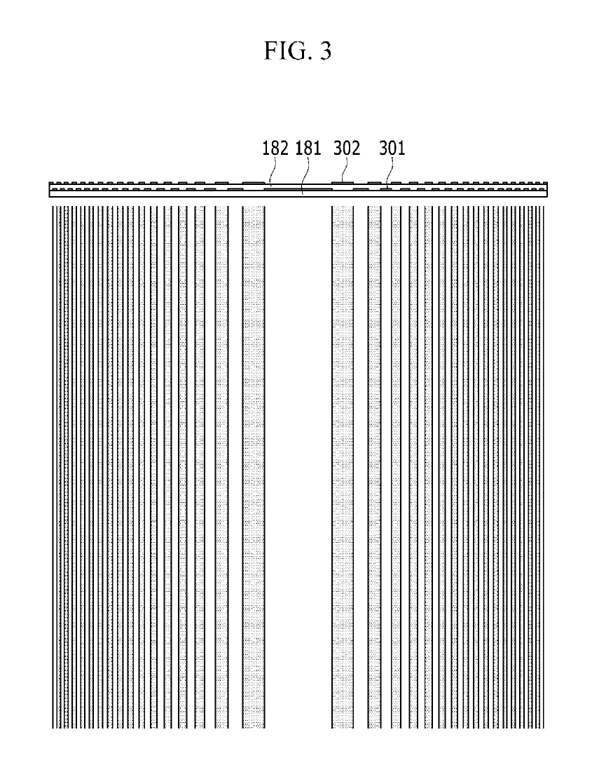

FIG. 3 is a cross-sectional view and a layout view of the lower lens electrode 300 of a liquid crystal lens according to an example embodiment. In the lower lens electrode 300, a plurality of branch electrodes (the first lens electrode 301 and the second lens electrode 302) are disposed with a stripe shape (as shown in the layout view of FIG. 3). The branch electrodes 301/302 are respectively disposed with a constant pattern, and one pattern forms one unit lens electrode. That is, FIG. 3 shows one unit lens electrode. The unit lens electrode includes a first insulating layer 181, a plurality of first lens electrodes 301, a second insulating layer 182, and a plurality of second lens electrodes 302. The first lens electrodes 301 are formed on the first insulating layer 181, the second insulating layer 182 is formed on the first insulating layer 181 formed with the first lens electrodes 301, and the second lens electrodes 302 are formed on the second insulating layer 182. Accordingly, the first lens electrodes 301 and the second lens electrodes 302 that are formed with different layers are electrically insulated from each other.

The unit lens has a shape in which a width of the lens electrode is increased closer to the center thereof. This unit lens functions as a plate type of liquid crystal lens. The zone plate is referred to as a Fresnel zone plate, and realizes a lens effect by using a diffraction phenomenon. The liquid crystal lens functions like the Fresnel lens because a plurality of branch electrodes are applied with different voltages and the degree of alignment of the liquid crystal molecules changes across the liquid crystal lens.

FIG. 2A shows a structure of a general Fresnel lens, and FIG. 2B is an enlarged view of a portion indicated by a dotted line in FIG. 2A. Straight lines that form the step shape shown in FIG. 2B indicate a zone plate phase distribution. FIG. 2C is a view of a liquid crystal lens according to an example embodiment.

As shown in FIG. 2C, and discussed above, the liquid crystal lens includes the lower substrate 100, the upper substrate 210 facing the lower substrate, and the liquid crystal layer 3 interposed between the lower substrate and the upper substrate. As discussed above, the first substrate includes the lower substrate 100, the first insulating layer 181 formed on the lower substrate, a plurality of first lens electrodes 301, the second insulating layer 182, and a plurality of second lens electrodes 302. The second insulating layer 182 is disposed between the first lens electrode 301 and the second lens electrode 302 such that the first electrodes and the second electrodes are formed at different layer and are electrically insulated from each other.

The first lens electrode 301 and the second lens electrode 302 may include a transparent conductive oxide. For example, the first lens electrode 301 and the second lens electrode 302 may include indium tin oxide (ITO) or indium zinc oxide (IZO).

The first insulating layer 181 and the second insulating layer 182 include an insulating material that transmits light. For example, the first insulating layer 181 and the second insulating layer 182 may include a silicon nitride (SiNx) or a silicon oxide (SiOx). The first insulating layer 181 is formed on the lower substrate, the first lens electrode 301 is formed on the first insulating layer 181, the second insulating layer 182 is formed on the first insulating layer 181 formed with the first lens electrode 301, and the second lens electrode 302 is formed on the second insulating layer 182.

The upper lens electrode 310 is formed on the upper substrate 210. The upper lens electrode 310 may include a transparent conductive oxide material. For example, the upper lens electrode 310 may include indium tin oxide (ITO) or indium zinc oxide (IZO). The upper lens electrode 310 rearranges the liquid crystal molecules of the liquid crystal layer along with the first lens electrode 301 and the second lens electrode 302. Accordingly, the first lens electrode 301, the second lens electrodes 302, the upper lens electrode 310, and the liquid crystal layer 3 form a unit lens.

The liquid crystal layer 3 may have a thickness of about 2 μm to 5 μm. The liquid crystal layer 3 has a relatively thin thickness such that high speed switching according to the alignment of the liquid crystal molecules may be realized. The liquid crystal layer 3 may be aligned so as to have a refractive index of a Fresnel lens by the first lens electrode 301, the second lens electrode 302, and the upper lens electrode 310.

If the driving voltage is applied to the liquid crystal lens, a potential is generated between the first lens electrode 301 and second lens electrode 302, and the upper lens electrode 310, such that the liquid crystal molecules of the liquid crystal layer 3 interposed between the first lens electrode 301 and second lens electrode 302, and the upper lens electrode 310, are rearranged. Accordingly, the unit lens may have the same phase difference as the Fresnel lens.

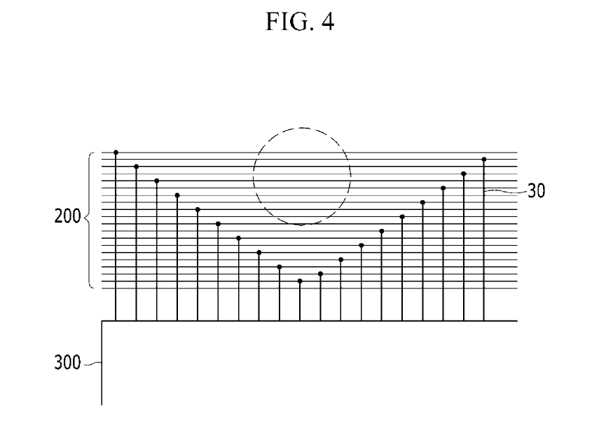

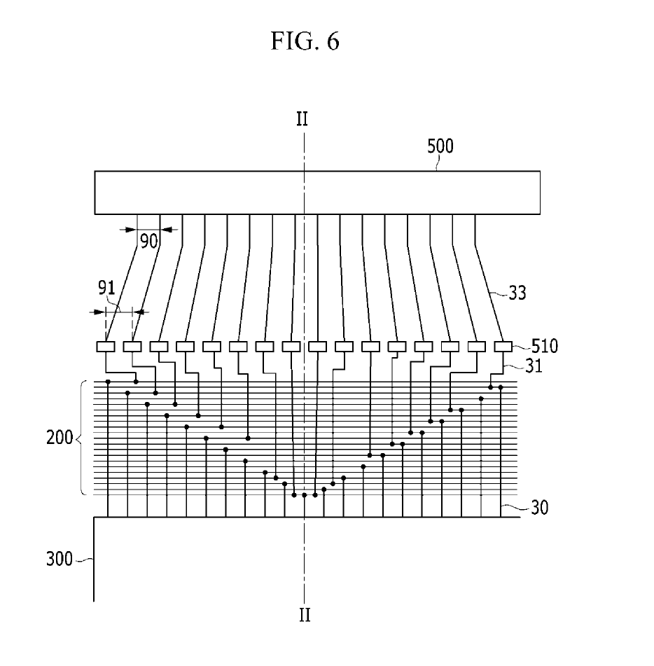

To drive the above liquid crystal lens, the liquid crystal lens has a driver and wiring to supply the voltage, as shown in FIG. 1. Next, the driver and the wiring of the liquid crystal lens according to an example embodiment will be described with reference to FIG. 4 and FIG. 6.

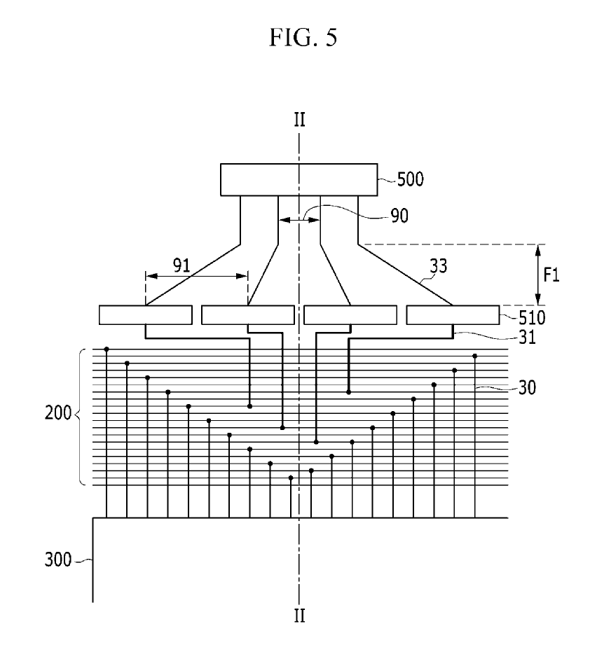

FIG. 4 shows a connection of the wiring and a liquid crystal lens. FIG. 5 shows a connection shape of a driver of a liquid crystal lens, wiring, and a lens electrode according to a comparative example. FIG. 6 shows a connection shape of a driver of a liquid crystal lens, wiring, and a lens electrode according to an example embodiment.

A liquid crystal lens according to an example embodiment will be described with reference to FIG. 6.

Firstly, the driver 500 will be described. The driver 500 is connected to the wiring by a second electrode 31 to supply the voltage to the wiring 200, and the wiring 200 is connected to each of the separate lens electrodes 301 and 302 by a first electrode 30 to supply the voltage.

In FIG. 5 and FIG. 6, one driver 500 is shown, however a plurality of drivers may be provided. As the size of the liquid crystal lens is increased, more drivers may be provided. The driver has a plurality of channels, and a driver pad wire 33 is connected to each channel. The driver pad wires 33 are regularly formed with a predetermined interval therebetween, and a distance between two adjacent driver pad wires 33 is a driver pad wire period 90.

Each driver pad wire 33 is connected to a second electrode 31 through a second electrode connection 510. The second electrode connection forms a contact between the driver pad wire 33 and a second electrode 31. In general, the driver pad wire 33 is formed of a metal material and the second electrode 31 is formed of the transparent conductive material such that a contact portion for the different materials is required. That is, compared with resistance of the metal material of the driver pad wires, resistance of the transparent conductive material of the second electrode is high such that a connection to accord the contact resistance is required. Therefore, by expanding the contact area of the second electrode 31 having the higher resistance to be used as a second electrode connection 510, the contact resistances of the two materials are accorded with each other in the second electrode connection 510.

The number of the second electrode connections 510 is the same as a number of the second electrodes 31. The second electrode connection 510 is regularly formed with the predetermined interval, and the distance between the adjacent second electrode connections 510 is a second electrode period 91.

The second electrode material may IZO.

The wiring 200 is positioned between the driver 500 and the lens electrode 300, and a plurality of individual wires of the wiring 200 are positioned in parallel and in a direction that crosses (or is perpendicular to) the direction of the second electrodes 31. The wiring 200 is connected to the driver through the second electrodes 31 thereby receiving the voltage. Also, the wiring 200 is connected to each separate branch lens electrode 301/302 (as shown in FIG. 3) through the first electrode 30, thereby supplying the voltage to the separate branch lens electrodes.

The first electrode material may be IZO.

One wire of wiring 200 is connected to one branch lens electrode 301/302 of the lower lens electrode 300 in a one to one ratio, thereby supplying the voltage to each branch lens electrode. That is, the separate branch lens electrodes forming one unit lens must be respectively applied with the different voltage such that one separate branch electrode is connected to one separate first electrode 30, which is connected to one separate wire of wiring 200. Accordingly, the number of the wires of wiring 200 is the same as a number of the separate branch lens electrodes 301/302 existing in the unit lens electrode.

Each wire of wiring 200 is sequentially connected to the lower lens electrode 300. The uppermost wires of wiring 200 are connected to the separate branch lens electrodes 301/302 positioned at an edge position among the unit electrodes, and the lowermost wires of wiring 200 are connected to the separate branch lens electrodes positioned at the centermost position among the unit electrodes. Accordingly, as shown in FIG. 4, the connection shape of the wiring 200 and the first electrode 30 may be triangular, and the center portion (indicated by a circular dotted line) of the wiring portion 200 is not connected to the lens electrode 300, but is exposed.

In the case that the lower lens electrode 300 includes the first lens electrodes 301 and the second lens electrodes 302 electrically insulated from each other, the wires may be respectively connected the first lens electrode 301 and the second lens electrode 302 through a separate process. That is, after a portion of the wires of wiring 200 are firstly and respectively connected to the first lens electrodes 301, the passivation layer and the second electrode are formed on the first lens electrode, and then the remaining wires of wiring 200 that is not connected to the first electrode may be connected to the second lens electrode.

In general, to sequentially connect the separate lens electrodes forming one unit electrode, the wires may be alternately connected to the right and left electrodes with reference to one unit lens electrode. That is, odd-numbered wires may be connected to the left separate electrodes of the unit lens electrode, and even-numbered wires may be connected to the right separate electrodes of the unit lens electrode.

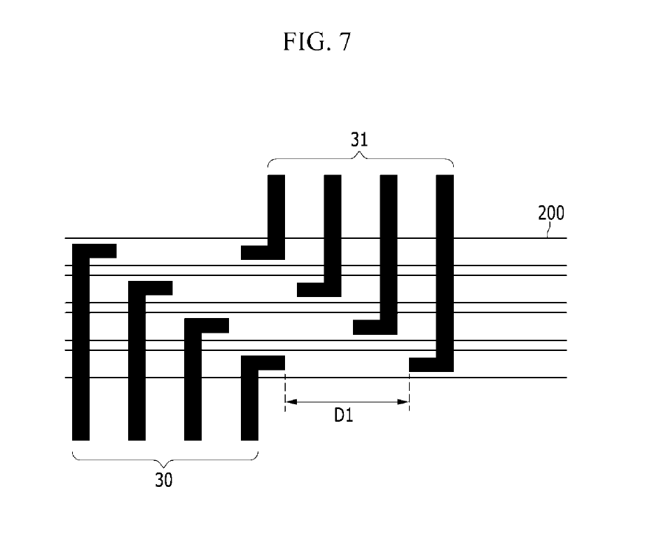

FIG. 7 is an enlarged view of a connection shape of a first electrode 30 and a second electrode 31 connected to wires 200.

Referring to FIG. 7, the first electrode 30 and the second electrode 31 connected to one wire of wiring 200 are separated by a distance D1. D1 may be, for example, more than 1 μm. The separation distance D1 may be, for example, in a range of 1 μm to 10 μm. The first electrode 30 and the second electrode 31 connected to one wire of wiring 200 are formed so as to be separated by the predetermined interval, and accordingly, a contact problem therebetween is not generated.

The exposed region of the wiring is connected to the driver through the second electrode 31.

In the liquid crystal lens according to example embodiments, the second electrode period 91 is similar to the driver pad wiring period 90 (as shown in FIG. 6). In an example embodiment, a difference between the second electrode period 91 and the driver pad wiring period 90 may be less than 1 μm.

Accordingly, a fan-out portion that would be required by a larger difference between the pad wiring period 90 and the second electrode period 91 of the driver may be omitted. In general, when the driver pad wiring period 90 is shorter than the second electrode period 91, a fan-out portion to accord the different periods is required. To compensate such a difference of the driver pad wiring period 90 and the second electrode period 91, the fan-out portion is formed with an arc shape between the driver pad wires 33 and the second electrode connection 510. The fan-out portion is a region that must be blocked by a black matrix. When the fan-out portion is omitted, the light blocking region may be reduced by a length of the fan-out portion, thereby reducing a bezel length.

Also, when the driver pad wiring period 90 is shorter than the second electrode period 91, the number of the second electrodes is smaller than the number of the driver pad wires, so a large number of the driver pad wires are not connected to the wiring and remain. Because the number of the second electrodes connected to the wiring is therefore small, it is difficult to sufficiently supply the voltage to the wiring from the driver such that applying it to a large sized liquid crystal lens is difficult.

However, in the liquid crystal lens according to example embodiments, the driver pad wiring period 90 is similar to the second electrode period 91. Accordingly, the fan-out portion to compensate the period difference is not necessary and the bezel may be minimized. Further, most of the driver pad wires are connected to the second electrode, and a sufficient number of the second electrodes are connected to the wires such that a sufficient voltage may be supplied to the wires from the driver. Accordingly, the large sized liquid crystal lens may also be stably driven. In an example embodiment, more than 80% of the driver pad wires may be connected to the second electrode.

In an example embodiment, one driver may, for example, have 966 driver pad wires. Among the 966 driver pad wirings, 780 driver pad wires may be connected to the second electrodes. The number of the driver pad wires and the number of the second electrodes connected to the driver pad wires may be changed according to the size of the liquid crystal lens panel.

FIG. 5 shows a connection shape of a driver of a liquid crystal lens, wiring, and a lens electrode according to the comparative example. Referring to FIG. 5, the driver pad wiring period 90 at the driver is shorter than the second electrode period 91. Accordingly, the fan-out portion F1 is generated by the period difference therebetween. Accordingly, the region covered by the black matrix is increased by the width F1 compared with the liquid crystal lens according to the example embodiments.

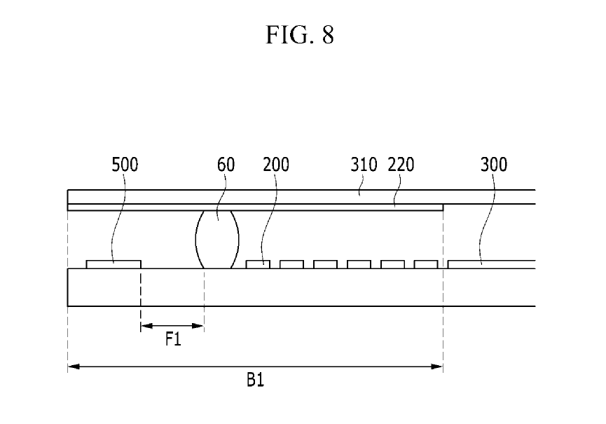

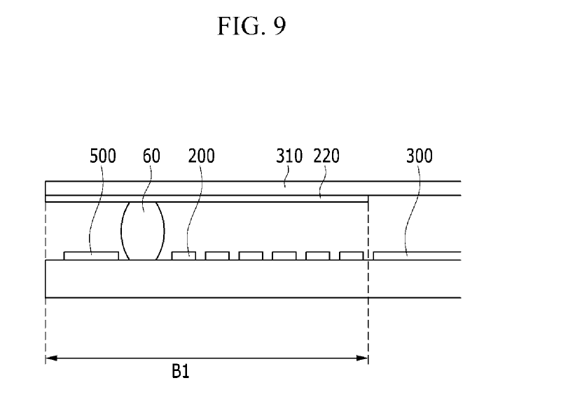

In the liquid crystal lens, the region where the driver and the wiring are disposed must be covered by the black matrix. FIG. 8 is a cross-sectional view of a liquid crystal lens according to a comparative example taken along the line II-II of FIG. 5. FIG. 9 is a cross-sectional view of a liquid crystal lens according to an example embodiment taken along the line III-III of FIG. 6.

Referring to FIG. 8, a black matrix 220 is positioned at the upper substrate 210. The black matrix is positioned to entirely cover a driver 500, a fan-out portion F1, a sealant 60, and wiring 200 that are positioned at the lower substrate 100, and a length thereof is B1.

However, referring to FIG. 9 as a cross-sectional of the liquid crystal lens according to an example embodiment, the black matrix 220 is positioned to cover the driver 500, the sealant 60, and the wiring 200 positioned at the lower substrate. Accordingly, the length of the region covered by the black matrix is decreased by the width F1.

The region where the light is blocked by the black matrix becomes the bezel of the display device. Accordingly, in the liquid crystal lens according to example embodiments, the driver pad wiring period and the second electrode period are similarly formed such that the fan-out portion may be omitted and the bezel may be reduced by the length of the fan-out portion.

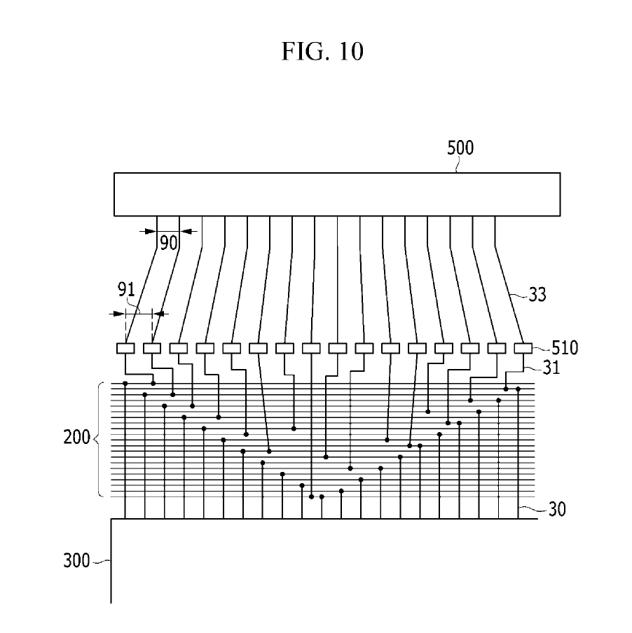

Referring to FIG. 6, in the present disclosure, the second electrodes 31 and the wires of wiring 200 are connected with the regular straight shape. However, the connection shape of the second electrodes and the wires is not limited thereto. FIG. 10 shows one shape in which the second electrode 31 is freely connected to the wiring 200. As shown in FIG. 10, in another example embodiment, the second electrode 31 may have any shape according to necessity such as a straight line shape, an oblique line shape, and a bent line shape. In the region of the wiring 200, the distance between adjacent second electrodes 31 may not be uniform.

In another example embodiment, the wires of wiring 200 that are connected to the center lens electrode that is longest among the unit lens electrode 300 may be connected to the second electrode 31. As previously described with respect to FIG. 3, the width of the separate lens electrode (the first lens electrode 301 and the second lens electrode 302) is wider closer to the center from the edge of the unit lens electrode. Accordingly, because the area of the lens electrode positioned at the center is largest, it is preferable that the supplied voltage is larger. To stably supply the voltage to the center lens electrode, two or more second electrodes 31 may be connected to the wires of wiring 200 that are connected to the center lens electrode.

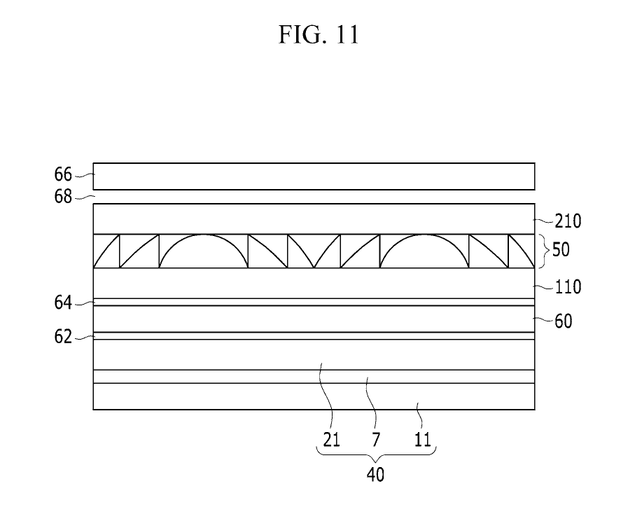

A display device applied with the liquid crystal lens module will be described with reference to FIG. 11. FIG. 11 shows a display device including a liquid crystal lens module. As shown in FIG. 11, the display device includes a display panel 40 and a liquid crystal lens module 50 positioned on the display panel. The display panel 40 may be various display panels such as a liquid crystal display (LCD) panel, an electrophoretic display panel (EDP), an organic light emitting display (OLED) panel, and a plasma display panel (PDP). In the present example embodiment, as an example of the display panel 40, the liquid crystal display (LCD) panel is described.

The display panel includes a first substrate 11 and a second substrate 21 facing to each other, and a liquid crystal layer 7 positioned between the substrates. Liquid crystal molecules are aligned according to a potential applied to electrodes formed at the first substrate and the second substrate, thereby displaying images.

The first substrate includes a plurality of pixel areas. In each pixel area, a gate line (not shown) extending in a first direction, a data line (not shown) extending in a second direction intersecting the first direction and insulated from the gate line, and a pixel electrode (not shown) are formed. Also, in each pixel, a thin film transistor (not shown) electrically connected to the gate line and the data line and electrically connected to the corresponding pixel electrode is provided. The thin film transistor provides a driving signal to a side of the corresponding pixel electrode. Also, a driver IC (not shown) may be formed at one side of the first substrate. The driver IC receives various signals from the outside, and outputs the driving signal driving the display panel 40 to a side of the thin film transistor in response to the various input control signals.

The second substrate may include RGB color filters realizing predetermined colors by using light provided from a backlight unit (not shown) on one surface, and a common electrode (not shown) formed on the RGB color filters and facing the pixel electrode. Here, the RGB color filters may be formed through a thin film process. On the other hand, in the present invention, the color filters are formed at the second substrate, but it is not limited thereto. For example, the color filters may be formed on the first substrate. Further, the common electrode of the second substrate may be formed at the first substrate.

The liquid crystal layer 7 is arranged in a predetermined orientation by the voltage applied to the pixel electrode and the common electrode such that transmittance of the light provided from the backlight unit is changed, thereby displaying the image through the display panel 40. In the case that the backlight unit does not exist, the transmittance of the light incident to the front surface of the display panel and reflected is controlled, thereby displaying the images.

The liquid crystal lens 50 is positioned on the display panel. The description of the liquid crystal lens is the same as the above description. The detail description for similar constituent elements is omitted. The liquid crystal lens is separated from the display panel 40 to obtain a lens focus distance. Accordingly, a gap spacing layer is positioned between the liquid crystal lens 50 and the display panel 40.

The gap spacing layer may be an interval maintaining plate 60 formed of transparent glass or plastic.

A bottom surface of the interval maintaining plate 60 is adhered on the display panel 40 by an optical adhesive 62, and a top surface thereof is adhered to a bottom surface of the liquid crystal lens 50 by an optical adhesive 64. The optical adhesives 62 and 64 are formed of an optically transparent material to not substantially generate a difference between the refractive index of the optical adhesives 62 and 64 and the refractive indexes of the display panel 40, the interval maintaining plate 60, and the liquid crystal lens 50.

A cover glass plate 66 may be positioned on the top surface of the liquid crystal lens 50 to protect the liquid crystal lens 50. The cover glass plate may be formed of a tempered glass.

Also, an air gap (air layer) 68 of more than 5 mm may be formed between the liquid crystal lens 50 and the cover glass plate 66.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the disclosure, including the appended claims.

<Description of Symbols>

| | |
|---|---|
| 100: lower substrate | 200: wiring |
| 210: upper substrate | 220: black matrix |
| 300: lower lens electrode | 310: upper lens electrode |
| 301: first lens electrode | 302: second lens electrode |
| 180: insulating layer | 181: first insulating layer |
| 182: second insulating layer | 183: third insulating layer |
| 3: liquid crystal layer | 90: driver pad wiring period |
| 91: second electrode period | 31: first electrode |
| 32: second electrode | 33: driver pad wiring |
| 60: sealant | 40: display panel |
| 11: first substrate | 21: second substrate |
| 50: liquid crystal lens module | 60: interval maintaining plate |
| 62, 64: optical adhesive | 66: cover glass plate |
| 68: air layer | |

What is claimed is:

1. A liquid crystal lens panel comprising:
a lower substrate;
a plurality of driver pad wires on the lower substrate positioned at an edge of the lower substrate;
a lower lens electrode on the lower substrate positioned at a center of the lower substrate;
a plurality of wires of a wiring on the lower substrate positioned between the plurality of driver pad wires and the lower lens electrode;
an upper substrate positioned facing the lower substrate;
an upper lens electrode formed at a bottom surface of the upper substrate;
a liquid crystal layer disposed between the upper substrate and the lower substrate;
a plurality of first electrodes connecting the lower lens electrode and the plurality of wires of the wiring; and
a plurality of second electrodes connecting the plurality of driver pad wires and the plurality of wires of the wiring,
wherein a distance between two adjacent driver pad wires is a driver pad wiring period and a distance between two second electrodes connected to the two adjacent driver pad wires is a second electrode period, and
a difference between the driver pad wiring period and the second electrode period is less than 1 μm.

2. The liquid crystal lens panel of claim 1, further comprising
a driver connected to the driver pad wires.

3. The liquid crystal lens panel of claim 1, wherein
more than 80% of wires among the driver pad wires are connected to individual second electrodes of the plurality of the second electrodes.

4. The liquid crystal lens panel of claim 2, wherein
a fan-out portion does not exist between the driver and the plurality of wires of the wiring.

5. The liquid crystal lens panel of claim 1, wherein
the lower lens electrode includes a group of a plurality of unit lens electrodes, and one unit lens electrode is formed of a plurality of separate branch electrodes, the branch electrodes in one unit lens electrode having a wider width closer to a center of the one unit lens electrode.

6. The liquid crystal lens panel of claim 5, wherein
a number of the separate branch electrodes forming one unit lens electrode is the same as a number of the wires of the wiring.

7. The liquid crystal lens panel of claim 5, wherein
the branch electrodes includes first lens electrodes and second lens electrodes insulated from the first lens electrodes.

8. The liquid crystal lens panel of claim 1, wherein
the first electrodes and the second electrodes include indium zinc oxide (IZO).

9. The liquid crystal lens panel of claim 8, wherein
a first electrode contact portion connecting a first electrode of the plurality of first electrodes to a wire of the wiring is separated from a second electrode contact portion connecting a second electrode of the plurality of second electrodes to a wire of the wiring.

10. The liquid crystal lens panel of claim 9, wherein
the separation distance between the first electrode contact portion and the second electrode contact portion is between 1 μm to 10 μm.

11. The liquid crystal lens panel of claim 1, wherein
the driver pad wires include indium tin oxide (ITO).

12. The liquid crystal lens panel of claim 1, wherein
the driver pad wires include a metal.

13. The liquid crystal lens panel of claim 5, wherein
a wire of the wiring connected to a center branch electrode that is largest among the branch electrodes forming the unit lens electrode is connected to two or more second electrodes.

14. A display device comprising:
a display panel displaying an image; and
a liquid crystal lens panel on the display panel,
wherein the liquid crystal lens panel includes:
a plurality of driver pad wires on the lower substrate positioned at an edge of the lower substrate;
a lower lens electrode on the lower substrate positioned at a center of the lower substrate;
a plurality of wires of a wiring on the lower substrate positioned between the plurality of driver pad wires and the lower lens electrode;
an upper substrate positioned facing the lower substrate;
an upper lens electrode formed at a bottom surface of the upper substrate;
a liquid crystal layer disposed between the upper substrate and the lower substrate;
a plurality of first electrodes connecting the lower lens electrode and the plurality of wires of the wiring; and
a plurality of second electrodes connecting the plurality of driver pad wires and the plurality of wires of the wiring,
wherein a distance between two adjacent driver pad wires is a driver pad wiring period and a distance between two second electrodes connected to the two adjacent driver pad wires is a second electrode period, and
a difference between the driver pad wiring period and the second electrode period is less than 1 μm.

15. The display device of claim 14, wherein
the display panel is one selected from a group including a liquid crystal display (LCD) panel, an electrophoretic display panel (EDP), an organic light emitting display (OLED) panel, and a plasma display panel (PDP).

16. The display device of claim 14, wherein
an interval maintaining layer made of a transparent glass or plastic is positioned between the display panel and the liquid crystal lens panel.

17. The display device of claim 14, wherein
more than 80% of wires among the plurality of driver pad wires of the liquid crystal lens panel are connected to individual second electrodes of the plurality of the second electrode.

18. The display device of claim 14, the liquid crystal lens panel further including a driver positioned between the edge of the lower substrate and the plurality of driver pad wires, wherein
a fan-out portion does not exist between the driver and the plurality of wires of the wiring.

19. The display device of claim 14, wherein
a first electrode contact portion connecting a first electrode of the plurality of first electrodes to a wire of the wiring is separated from a second electrode contact portion connecting a second electrode of the plurality of second electrodes to a wire of the wiring.

20. The display device of claim 14, wherein
the lower lens electrode includes a group of a plurality of unit lens electrodes, and one unit lens electrode is formed of a plurality of separate branch electrodes, the branch electrodes in one unit lens electrode having a wider width closer to a center of the one unit lens electrode, and a wire of the wiring connected to a center branch electrode that is largest among the branch electrodes forming the unit lens electrode is connected to two or more second electrodes.
